(19) United States
(12) Patent Application Publication
(10) Pub. No.: US 2011/0036422 A1
(43) Pub. Date: Feb. 17, 2011

(54) AIR OVER OIL LUBRICATION DEVICE

(76) Inventor: Richard Thomas Hanley, Fountain Valley, CA (US)

Correspondence Address: GRACO MINNESOTA INC, PO BOX 1441, MINNEAPOLIS, MN, 55440, US

(21) Appl. No.: 12/990,269

(22) PCT Filed: Apr. 27, 2009
(86) PCT No.: PCT/US09/41799

§ 371 Date: Oct. 29, 2010

Related U.S. Application Data
(60) Provisional application No. 61/049,260, filed on Apr. 30, 2008.

(51) Int. Cl. F16K 15/00

(52) U.S. Cl. 137/511

(57) ABSTRACT

A multiple point air over oil lubrication device or air over oil distributing valve assembly, which consists of a series progressive modular divider valve, air injection manifold, proprietary individual one-way air injectors with integral check valves that allow air to flow towards the individual bearing points but prevent oil from flowing backwards into the air manifold or to another bearing point, a lube oil flow verification device, and an air pressure verification sensor.

### TECHNICAL FIELD

This application claims the benefit of U.S. Application Ser. No. 61/049,260, filed Apr. 30, 2009, the contents of which are hereby incorporated by reference.

### BACKGROUND ART

Manifolds for divider valves are in general well known.

### DISCLOSURE OF THE INVENTION

It is an object of this invention to combine an intermittent oil flow and a constant air flow for the purpose of providing specifically engineered amounts of oil lubrication to separate (discreet) rotating bearing points while assuring through design, that if oil is prevented from reaching any bearing point, the oil cannot be diverted to another bearing point and through design, that the individual bearing point lube oil flow failure can be identified and a fault signal can be generated to initiate appropriate action to prevent damage to the bearing point not receiving the required oil lubrication.

After mounting the air over oil distributing valve assembly onto the equipment to be lubricated, the air over oil distributing valve assembly is installed and operates as follows:

1) A continuous flow of 10-40 PSI clean air supply is connected to the assembly using either the left hand or right hand air inlet ports of the air injection manifold component of the air over oil distributing valve assembly.

2) A 150-3500 PSI oil supply is connected to the oil inlet of the series progressive divider valve component of the air over oil distributing valve assembly.

3) A lube oil verification device, consisting of either a cycle indicator pin-limit switch assembly or a directly mounted proximity switch, is mechanically connected to one of the valve units of the series progressive divider valve component of the air over oil distributing valve assembly and electronically connected to the dedicated lube system controller or the lubricated equipment PLC control device.

4) An air pressure verification device, consisting of an air pressure sensor factory set at the minimum required operating air pressure for the air over oil distributing valve assembly is mechanically connected to either the left hand or right hand air sensor ports of the air injection manifold component of the air over oil distributing valve assembly and electronically connected to the dedicated lube system controller or the lubricated equipment PLC control device.

At programmed intervals, the system control turns on the lube oil supply line causing the series progressive divider valve to cycle thus dividing the incoming oil flow into proportioned amounts which are each ported to the specific individual valve outlets. As the valve cycles, the lube oil verification device counts each individual valve cycle, and transmits a signal of that count to the control device. A constant supply of air is evenly distributed throughout the drill passages of the air injection manifold and is forced into the inlets of the individual one-way air injectors, which are connected to the front ports of the valve units of the series progressive modular divider valve. The air supply pressure opens the one-way valves in each one-way air injector allowing the air to flow into the front port of each valve unit where it is internally ported to the individual outlet connected to that valve. The oil and air meet in the outlet port and the air forces the oil ringlets or drops down the lube line connecting the air over oil distributing valve assembly outlets to the bearing point inlets, once the system control receives the required number of divider valve cycle counts from the lube oil verification device, the controller turns off the oil supply pump, resets the timers and waits for the next programmed lube event.

The air pressure verification sensor constantly monitors air pressure in the air injection manifold.

The air over oil distributing valve assembly is comprised of the following components:

1) A series progressive modular divider valve which divides the volume of oil pumped into its inlet port into precisely engineered amounts which are individually and separately dispensed from the divider valves discreet outlet ports. By design, if a series progressive modular divider valve cycles, then oil, in the engineered quantities, must be distributed to the individual working outlets.

2) An air injection manifold, whose uniquely drilled air passages enable it to evenly distribute air flow and air pressure throughout the manifold body.

3) Proprietary sealed ONE-WAY air injectors, which allow air to discretely pass from the air injection manifold into each individual front port of the series progressive divider valve. These ONE-WAY air injectors allow air to pass into the valve but will not allow oil to flow back out of the valve and into the air injection manifold.

A lube oil cycle verification device, which consists of a cycle pin-limit switch assembly or a directly mounted proximity switch, is mechanically connected to any one of the valve units of the series progressive modular divider valve and electronically connected to the control device. When the pump is turned on, the series progressive modular divider valve begins to operate and the lube cycle verification device is actuated by the divider valve. This mechanical actuation produces an electronic signal for each for each cycle of the valve. These signals are electronically transmitted to the control device.

When the number of cycle count signals equals the programmed cycle count requirement, the control device turns off the pump and the oil supply is intentionally terminated. If the control initiates an oil lube event and the control device fails to receive any or fewer counts than the programmed requirement, the control device will generate an alarm signal indicating that a LUBE OIL FAULT condition has occurred. In this method lube oil flow is verified to each and every bearing point serviced by the air over oil distributing valve assembly.

An air pressure sensor is mechanically connected to the air injection manifold and electronically connected to a control device. If the air pressure within the air injection manifold drops below the engineered factory set point for the air over oil lube system, the sensor sends a signal indicating a LOW AIR PRESSURE FAULT condition has occurred. In this method pressurized air flow to the air injection manifold is verified to assure proper function of the air over oil distributing valve assembly.

The air over oil distributing valve assembly divides the volume of oil, injected into the series progressive divider valves inlet port from an intermittently pressurized single supply line, into appropriately engineered independent oil volumes, which are ported by the valves internal hydraulic passages to the divider valves discreet outlets, which are connected to individual bearing points by lube supply lines. The oil volume output of each valve outlet port is injected into the lube supply line connected to that specific outlet.

A constant pressurized air flow is induced into the air injection manifold. By design, the air volume and air pressure are evenly distributed throughout the manifold by the manifold air passage drillings. The air pressure within the manifold causes air to enter the inlet ports of the independent one-way air injectors which are each connected to the corresponding front port of the series progressive divider valve assembly valve units. The one-way injector internal check valve is opened by the air pressure acting on it and air passes from the manifold, through the air injector, into the front port of the valve, and to the specific series progressive divider valve oil outlets internally connected to the front port of the valve.

In this manner, the common air supply is separated into equal volumes and pressures which are then ported to the individual oil outlets of the Air over Oil Distributing Valve Assembly. The air then carries the oil drops or ringlets down the lube supply lines to the individual bearing points being lubricated by the Air over Oil Distributing Valve Assembly.

The lube oil cycle verification device and the air pressure sensor device confirm that both AIR and OIL are properly flowing through the Air over Oil Distributing Valve Assembly. In the event that either OIL or AIR flow is interrupted, a fault condition signal is generated and the appropriate corrective action may be taken prior to the incurrence of damage to the equipment being lubricated by the Air over Oil Distributing Valve Assembly. The sealed, one-way air injector with integral reverse flow lube oil one-way check valve is the proprietary critical component which allows this device to uniquely verify proper Air over Oil Distributing Valve Assembly function and insures that a LUBE OIL FAULT CONDITION is identified before damage to critical bearings.

In the event that a lube supply line is crushed or a bearing point is plugged, the one-way air injector will not allow the oil to flow back into the air supply and because the unique design isolates each lubricant outlets air and oil supply from every other lubricant outlet, the failure of oil to exit the problem lube supply line will eventually cause the oil backed up into the supply line to prevent the valve from cycling. At that time, the lube oil verification device will not be able to send a cycle count signal to the control device and the control device will generate a lube fault condition alarm in time to prevent damage to the problem bearing point.

The manifold of the instant invention provides are discrete air and discrete oil and such that there is no mixing of the two in the manifold.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 shows the air over oil manifold assembly mounted to a divider valve assembly.

FIG. 2 shows a top view of the air over oil manifold assembly.

FIG. 3 shows a side view of the air over oil manifold assembly.

FIG. 4 shows a side view of the air over oil manifold assembly mounted to a divider valve assembly.

FIG. 5 shows the air injector with integral reverse flow lube oil one way check valve.

FIG. 6 shows a cross-section of the air injector with integral reverse flow lube oil one way check valve.

FIG. 7 shows the manifold with the internal passages connecting the various ports.

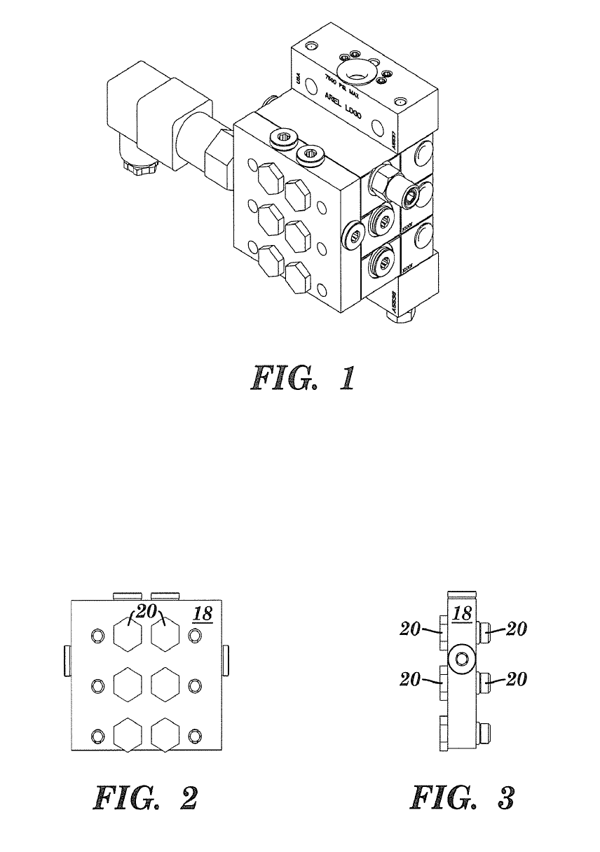

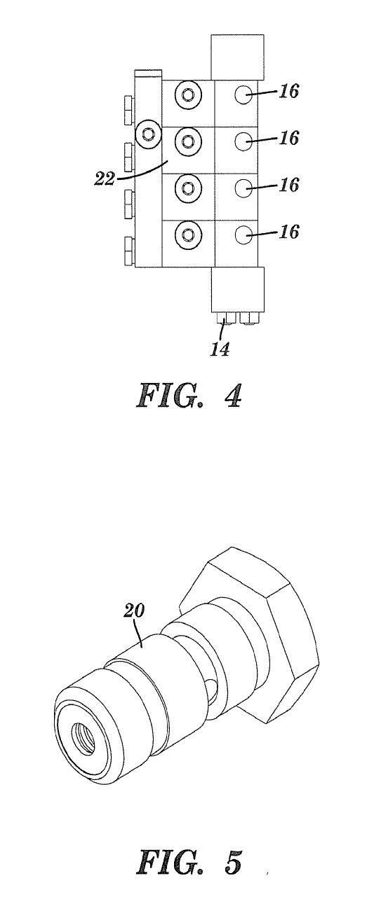

### BEST MODE FOR CARRYING OUT THE INVENTION

The air over oil distributing valve assembly 10 is comprised of the following components:

1) A series progressive modular divider valve 12 which divides the volume of oil pumped into its inlet port 14 into precisely engineered amounts which are individually and separately dispensed from the divider valves discreet outlet ports 16. By design, if a series progressive modular divider valve 12 cycles, then oil, in the engineered quantities, must be distributed to the individual working outlets 16.

2) An air injection manifold 18, whose uniquely drilled large diameter air passages 32 enable it to evenly distribute air flow and air pressure throughout the manifold body.

3) Proprietary sealed ONE-WAY air injectors 20, which allow air to discretely pass from the air injection manifold into each individual front port 22 of the series progressive divider valve 12. These ONE-WAY air injectors allow air to pass into the valve 12 but will not allow oil to flow back out of the valve 12 and into the air injection manifold 18.

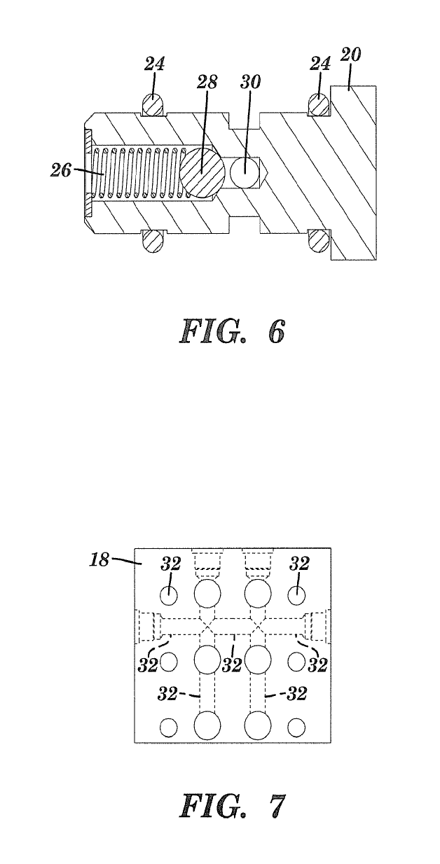

Air injector check valves 20 are shown in detail in FIGS. 5 and 6 are provided with sealing o-rings 24 and a spring 26 loaded ball 28 which prevents oil flow back into the manifold 18 through passages 30.

It is contemplated that various changes and modifications may be made to the air over oil manifold assembly without departing from the spirit and scope of the invention as defined by the following claims.

1. In a manifold for use with a divider valve, said having at least one air inlet and a plurality of ports for mating with ports on said divider valve, the improvement comprising a check valve being located in each said manifold port, said check valve allowing only the flow of air from said manifold into said divider valve.

2. The manifold of claim 1 further comprising porting connecting said air inlet and said manifold ports.
